(19) United States
(12) Patent Application Publication
(10) Pub. No.: US 2026/0011810 A1
(43) Pub. Date: Jan. 8, 2026

(54) BATTERY THERMAL MANAGEMENT SYSTEMS AND METHODS

(71) Applicant: KS2 CORP INC., Montreal (CA)

(72) Inventor: Anthony Scappaticci, Montreal (CA)

(21) Appl. No.: 19/259,377

(22) Filed: Jul. 3, 2025

Related U.S. Application Data
(60) Provisional application No. 63/668,007, filed on Jul. 5, 2024.

(51) Int. Cl. H01M 10/635; H01M 10/615; H01M 10/625

(52) U.S. Cl. CPC H01M 10/635; H01M 10/615; H01M 10/625; H01M 2220/20

(57) ABSTRACT

Systems and methods for heating at least one battery pack having a plurality of battery cells and a plurality of heating elements is described. The systems and methods determine a required thermal profile, the required thermal profile relating to one or more battery cell temperatures of the plurality of battery cells over a period of time. The systems and methods receive operational information relating to the at least one battery pack and calculate an optimized power profile required to execute the required thermal profile based at least in part on the operational information. The systems and methods also modulate a driver signal for the plurality of heating elements based on the calculated optimized power profile, and the modulated driver signal causes the plurality of heating elements to heat the plurality of battery cells in accordance with the required thermal profile.

### CROSS-REFERENCE TO PREVIOUS APPLICATION

This application claims priority from U.S. provisional patent application 63/668,007 filed on Jul. 5, 2024, which is incorporated herein by reference in its entirety.

### FIELD

The present disclosure generally relates to the field of rechargeable batteries. In particular, various embodiments are described herein that relate to systems and methods for managing the temperature of rechargeable battery packs.

### INTRODUCTION

The following paragraphs are provided by way of background to the present disclosure. They are not, however, an admission that anything discussed therein is prior art or part of the knowledge of persons skilled in the art.

In the field of electric vehicles (EVs), battery packs are central to vehicle power systems. Such battery packs represent an integration of various technologies designed to provide sufficient energy storage, power delivery, safety, and longevity to propel a vehicle over considerable distances and in various operational environments. At the core of every battery pack are individual battery cells. These cells are typically lithium-ion (Li-ion) or, in some cases, lithium-polymer (Li-poly), due to their high energy density and relatively low weight compared to other battery chemistries. The choice of cells affects energy capacity, power output, and overall efficiency of the battery pack.

An EV battery pack is typically composed of hundreds to thousands of individual battery cells, arranged in series and parallel configurations to meet voltage and capacity requirements. Each cell contributes to the overall performance and range of the vehicle. Managing these cells collectively however poses significant challenges, such as cell balancing, thermal management, state of charge (SoC) estimation, and protection against overcharging or over-discharging.

Thermal management of battery packs poses a particularly difficult challenge, especially in cold climates. One method of heating battery packs is to use the energy stored in the battery packs themselves to provide heat. As will be appreciated by the skilled reader however, use of such energy has a negative impact on the remaining available energy of a battery pack and, in the case of EVs, vehicle range. Moreover, converting electrical energy into heat inherently involves losses. As such, known Battery Management Systems (BMSs) are inefficient and, in some cases, wasteful, thereby leading to reductions in range by up to 30% to 40% for some EVs in some climates.

There is therefore a clear need for systems and methods for managing the temperature of rechargeable battery packs that address the challenges and/or shortcomings described above.

### SUMMARY

Various embodiments of systems and methods for managing the temperature of rechargeable battery packs are provided according to the teachings herein. Generally, the present disclosure describes various embodiments of battery system managers for battery packs having a plurality of heating elements, the battery system managers determining a required thermal profile for a battery pack and a power profile required to execute the thermal profile.

According to an aspect of the present disclosure, there is disclosed a battery system manager for at least one battery pack having a plurality of battery cells and a plurality of heating elements. The battery system manager comprises one or more computer processors and one or more computer readable storage media for storing computer-implemented instructions. The one or more computer processors are configured to execute the computer-implemented instructions to cause the battery system manager to determine, in response to an activation signal, a required thermal profile, the required thermal profile relating to one or more battery cell temperatures of the plurality of battery cells over a period of time. The one or more computer processors are configured to execute the computer-implemented instructions to cause the battery system manager to also receive operational information relating to the at least one battery pack and calculate an optimized power profile required to execute the required thermal profile based at least in part on the operational information. The one or more computer processors are configured to execute the computer-implemented instructions to cause the battery system manager to modulate a driver signal for the plurality of heating elements based on the calculated optimized power profile, wherein the modulated driver signal causes the plurality of heating elements to heat the plurality of battery cells in accordance with the required thermal profile.

According to another aspect of the present disclosure, there is provided a method of heating at least one battery pack having a plurality of battery cells and a plurality of heating elements. The method comprises determining, in response to an activation signal, a required thermal profile, the required thermal profile relating to one or more battery cell temperatures of the plurality of battery cells over a period of time. The method also comprises receiving operational information relating to the at least one battery pack and calculating an optimized power profile required to execute the required thermal profile based at least in part on the operational information. The method also comprises modulating a driver signal for the plurality of heating elements based on the calculated optimized power profile, wherein the modulated driver signal causes the plurality of heating elements to heat the plurality of battery cells in accordance with the required thermal profile.

In some examples, the required thermal profile relates to changes in the one or more battery cell temperatures in order to allow safe charging of the at least one battery pack at a specific time.

In some examples, the required thermal profile relates to one or more changes in the one or more battery cell temperatures in order to allow safe charging of the at least one battery pack at multiple times during a specific time period.

In some examples, the required thermal profile relates to one or more changes in the one or more battery cell temperatures in order to allow safe charging of the at least one battery pack at multiple times during a time period.

In some examples, the one or more battery cell temperatures are determined for each battery cell in a subset of the plurality of battery cells.

In some examples, the operational information includes information that is input by a user, and the at least one battery pack is a power source of an electric vehicle and the information input by the user includes one or more of information required to set an operational mode of the system, information relating to when a user is expecting to charge battery pack, information relating to a location in which the user is expecting to charge battery pack, information relating to when, how often and/or where the user expects to regularly charge battery pack, and information relating to the expected use plan of the electric vehicle.

In some examples, the operational information includes information that is obtained by the battery system manager, and the at least one battery pack is a power source of an electric vehicle and the information that is obtained by the battery system manager includes positioning information relating to a geographic location of the battery pack, information usable to determine a charging schedule including information in relation to when and where the battery pack is charged, traffic information relating to current, future or past traffic conditions, information relating to current, future or past weather conditions, information relating to current, future or past ambient temperatures, information relating to the operation of one or more of the plurality of battery cells.

In some examples, the optimized power profile corresponds to the amount of power required to be delivered to the plurality of heating elements over a period of time in order for the one or more battery cell temperatures to conform to the required thermal profile.

In some examples, the optimized power profile corresponds to the minimum amount of power required to be delivered to the plurality of heating elements over a period of time in order for the one or more battery cell temperatures to conform to the required thermal profile.

In some examples, modulating a driver signal for the plurality of heating elements based on the calculated optimized power profile includes modulating the driver signal using pulse width modulation in order to deliver specific amounts of power to the heating elements over a period of time.

According to yet another aspect of the present disclosure, there is provided a thermal management system for at least one battery pack having a plurality of battery cells. The thermal management system comprises a plurality of heating elements, and a battery system manager as defined above.

In some examples, each of the plurality of heating elements are intercalated between each of the plurality of battery cells.

Other features and advantages of the present disclosure will become apparent from the following detailed description taken together with the accompanying drawings. It should be understood, however, that the detailed description and the specific examples, while indicating preferred embodiments of the systems and methods, are given by way of illustration only, since various changes and modifications that fall within the scope of this disclosure will become apparent to those skilled in the art from a reading of the detailed description.

### DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein. In the drawings:

FIG. 1 shows a schematic diagram of a thermal management system in accordance with embodiments of the present disclosure;

FIG. 2 shows a schematic diagram of a thermal management system and an interface device for controlling the thermal management system in accordance with embodiments of the present disclosure;

FIG. 3 shows a flow chart of a method of operation of a thermal management system and an interface device in accordance with embodiments of the present disclosure;

FIG. 4 shows a flow chart of another method of operation of a thermal management system and an interface device in accordance with embodiments of the present disclosure;

FIG. 5 shows a flow chart of yet another method of operation of a thermal management system and an interface device in accordance with embodiments of the present disclosure; and

FIG. 6 shows a flow chart of yet another method of operation of a thermal management system and an interface device in accordance with embodiments of the present disclosure.

Further aspects and features of the example embodiments described herein will appear from the following description taken together with the accompanying drawings.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may form the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein.

It should also be noted that the terms “connected” or “connection” as used herein can have several different meanings depending on the context in which these terms are used. For example, the terms connected or connection can have a mechanical or electrical connotation. For example, as used herein, the terms connected or connection can indicate that two elements or devices can be directly connected to one another or connected to one another through one or more intermediate elements or devices via an electrical signal, electrical connection, an electromagnetic signal, and/or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be also noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

Some elements herein may be identified by a part number, which is composed of a base number followed by an alphabetical or numerical suffix (e.g., 184A, or 184₁). Multiple elements herein may be identified by part numbers that share a base number in common and that differ by their suffixes (e.g., 184₁, 184₂, and 184₃). All elements with a common base number may be referred to collectively or generically using the base number without a suffix (e.g., 184).

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including one or more of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level programming language. The program code may be written in Rust, C++, C #, JavaScript, Python, or any other suitable programming language and may comprise modules or classes, as is known to those skilled in the art. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, solid-state storage, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

As used herein, the term “electric vehicle” or “EV” means any vehicle that utilizes one or more electric motors for propulsion including, but not limited to, full electric vehicles, hybrid electric vehicles, and plug-in hybrid electric vehicles.

As used herein, the term “battery pack” means a collection of individual batteries or cells arranged together to provide electrical energy storage. Battery packs are commonly used in electric vehicles (EVs), portable electronic devices, and renewable energy storage systems. The batteries within a pack are typically connected in series and parallel configurations to achieve the desired voltage, capacity, and power output.

As used herein, the term “battery management system” or “BMS” means any system that monitors and manages rechargeable batteries.

As used herein, the terms “battery system manager” and “power system manager” mean a system comprising software and/or hardware components that manage operational aspects of a battery based on factors internal to the battery, as well as factors external to the battery. As such, not all BMSs are battery system managers.

In accordance with the teachings herein, there are provided various embodiments of battery system manager systems and methods for at least one battery pack having a plurality of heating elements, the battery system manager configured to determine, in respond to an activation signal, a required thermal profile, the thermal profile relating to one or more battery cell temperatures of the at least one battery pack over a period of time. The battery system manager is also configured to receive operational information relating to the at least one battery pack, calculate an optimized power profile required to execute the thermal profile based at least in part on the operational information, and modulate a driver signal for the plurality of heating elements based on the calculated minimum power profile, wherein the modulated driver signal causes the plurality of heating elements to execute the thermal profile.

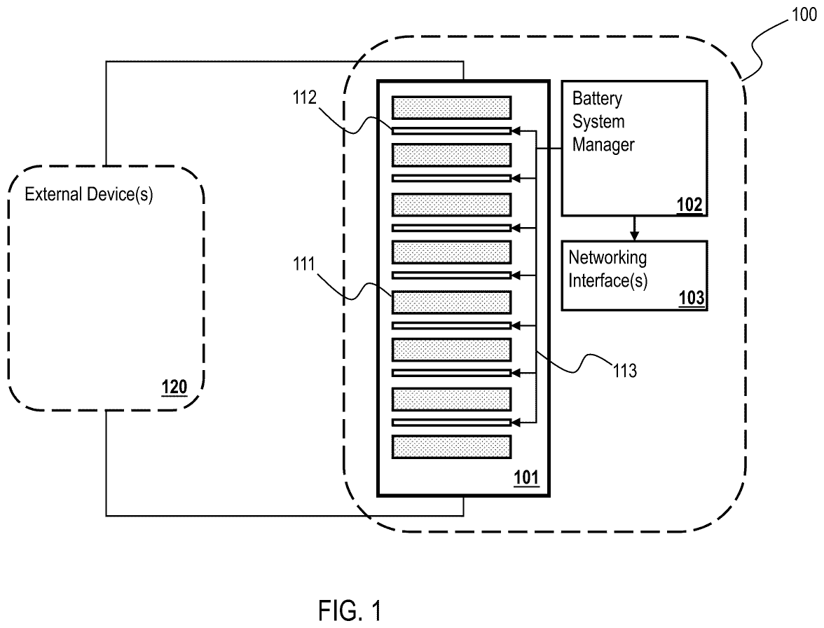

FIG. 1 illustrates a rechargeable battery thermal management system in accordance with an embodiment of the present disclosure. The rechargeable battery thermal management system is denoted generally by reference numeral 100. The thermal management system 100 includes a battery pack 101, a battery system manager 102, as well as a networking interface 103. While FIG. 1 illustrates the thermal management system 100 as being contained within one enclosure, it will be understood that the thermal management system 100 may include physically separated devices, where a first device may include the battery pack 101 which is connectable to a second device which includes the battery system manager 102. It will also be understood that the battery pack 101 and the battery system manager 102 are connected to each other when there are one or more external devices 120 connected to the battery pack 101, such as a charger or a load. It will also be understood that while FIG. 1 illustrates a single battery pack 101 connected to the battery system manager 102, some embodiments may include a plurality of battery packs 101 connected to the battery system manager 102. As such, as used herein, the term “battery pack 101” may include more than one battery pack.

As shown in FIG. 1, the battery pack 101 can be electrically connected to one or more external devices 120, which can be a charging device or one or more loads, such as one or more motors of an electric vehicle (EV). In a charging mode, the battery pack 101 may be supplied with power from the external device. In a discharging mode, the battery pack 101 can supply power to the external device(s).

The battery pack 101 may be a Lithium-based rechargeable battery. For example, a lithium-ion (Li-ion), lithium-polymer (LiPo) battery, or any equivalent rechargeable battery. For instance, the Li-ion battery may be a battery based on lithium cobalt oxide (LCO), lithium manganese oxide (LMO), lithium nickel manganese cobalt oxide (NMC), lithium iron phosphate (LFP), lithium nickel cobalt aluminum oxide (NCA), lithium titanate (LTO), or any equivalent li-ion battery.

The battery pack 101 may contain a plurality of battery cells 111. The manufacturing of battery cells compared to battery packs are two different industrial processes. Battery cells 111 are containers that chemically store energy. Battery cells 111 are connected in series and in parallel, into battery packs 101, to achieve desired voltage and energy capacity. The battery pack 101 is a complete enclosure that delivers power to, for example, an EV. Battery pack 101 also contains a plurality of heating elements 112. Heating elements 112 may be individually controllable by control signals passing through drive medium 113, which may include electrical connections, inductive couplings, or combinations thereof, as described in more detail elsewhere herein.

The heating of battery pack 101 in, for example, an EV is an important aspect of ensuring its optimal performance and longevity, especially in regions with cold climates. Lithium-ion batteries perform best within a specific temperature range, typically between 20° C. to 30° C. (68° F. to 86° F.). Outside this range, their efficiency and overall lifespan can be significantly affected. Exposure to very low temperatures (e.g., during the winter months in cold climates) can cause several issues including, but not limited to, reduced efficiency, capacity loss, and potential damage. Cold temperatures increase the internal resistance of battery pack 101, which reduces its efficiency and limits the amount of power that can be delivered to the load. In EVs, this results in decreased range and performance of the vehicle.

Cold weather can also reduce the usable capacity of battery pack 101 temporarily. When battery pack 101 is cold, it cannot deliver as much energy as it can at optimal temperatures, leading to decreased range per charge in EVs. Finally, if the temperature of battery pack 101 drops below a certain threshold, certain types of batteries (e.g., lithium-ion) can be damaged. Charging at extremely low temperatures or discharging rapidly in cold weather can also lead to degradation of battery cells 111 over time, thereby reducing their overall lifespan.

In some embodiments of the present disclosure, battery system manager 102 may control the drive signal transmitted through drive medium 113 by intermittently switching the drive signal on and off using known techniques such as Pulse Width Modulation (PWM). In such embodiments, the average power (and therefore heat) dissipated by heating elements 112 can be precisely controlled by controlling the duty cycle of the PWM drive signal. Because the average current is the current multiplied by the duty cycle of the drive signal, the dissipated heat may thereby be controlled very precisely by controlling the duty cycle of the PWM drive signal. Moreover, in some embodiments, the battery system manager 102 may control the operation of each heating element 112 individually by way of drive medium 113, thereby increasing the flexibility and precision with which the battery cells 111 of battery pack 101 may be heated.

In some embodiments, as shown in FIG. 1, heating elements 112 are located between battery cells 111. This structure, coupled with temperature sensors (not shown) capable of sensing the temperature of each battery cell 111 allows the battery system manger 102 to dynamically heat individual cells to greater or lesser extents, thereby increasing the overall efficiency and effectiveness of the thermal management system 100.

In some embodiments, heating elements 112 are resistive heating elements. Resistive heating is a process where electrical energy is converted into heat as current flows through a material with resistance. When an electric current passes through a resistive material, the resistance of the material causes it to heat up. In such embodiments, drive medium 113 may be a plurality of conductive electrical connections capable of delivering the required currents to drive heating elements 112.

In some embodiments, the heating elements 112 are inductive coils. Inductive heating is a method of heating an electrically conductive material by inducing electrical currents within it through electromagnetic induction. This process involves placing the material within an alternating magnetic field generated by an induction coil or transformer. In such embodiments, drive medium 113 may include a combination of electromagnetic field generators and inductively coupled coils placed between battery cells 111.

Thermal management system 100 comprises one or more networking interfaces 103. The structure of networking interfaces 103 is implementation-dependent and may vary between embodiments that support different types of connections and/or communication protocols, for example. The networking interfaces 103 could enable communications over wired and/or wireless connections between the battery system manager 102 of the thermal management system 100 and an interface device, as described in more detail elsewhere herein.

Moreover, the networking interfaces 103 could also enable communications over wired and/or wireless connections between the battery system manager 102 of the thermal management system 100 and the Internet 104. In general, networking interfaces 103 include a physical interface such as a port, connector, antenna, antenna array, or other component to interface with a communication medium, and a receiver and/or transmitter to process received signals and/or transmit signals for transmission.

In some embodiments, networking interfaces 103 can include a vehicle interface configured to communicate with other parts of an EV. In some embodiments, the vehicle interface may be configured to communicate via a vehicle communication and diagnostic system. In some embodiments, a vehicle communication and diagnostic system is a standard vehicle bus, such as a vehicle bus in accordance with the Society of Automotive Engineers' standard SAE J1939, or analogous systems, which are widely used by automotive manufacturers. As will be appreciated by the skilled reader, the ambient temperature and location of an EV in which the thermal management system 100 is installed may be determined by thermal management system 100 by way of processing information received from the vehicle interface.

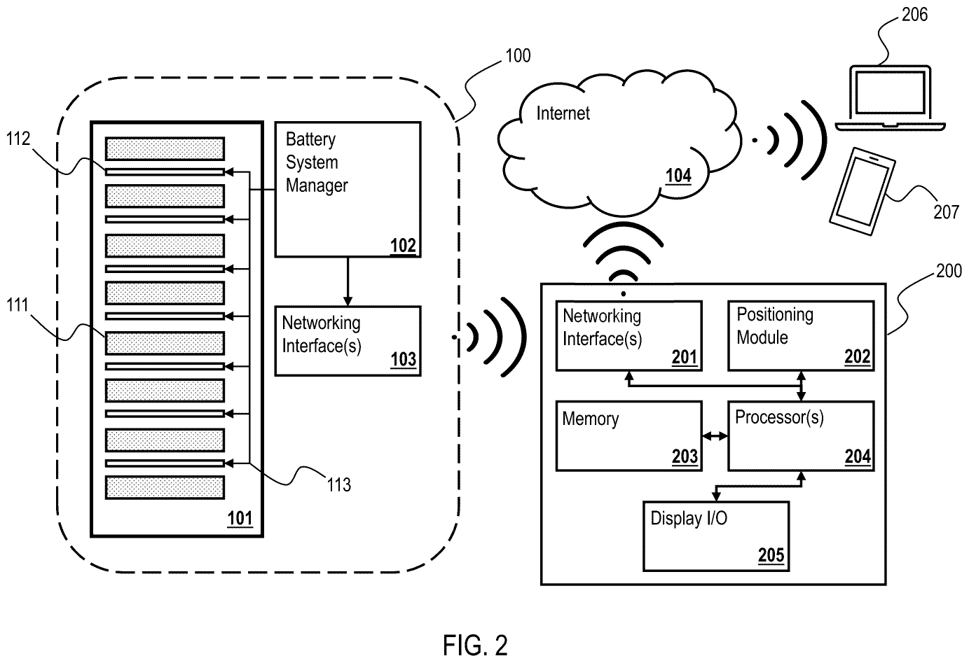

FIG. 2 shows an interface device 200 suitable for communicating with the thermal management system 100. In some embodiments, the interface device 200 may comprise processor(s) 204, memory 203 and networking interface(s) 201. Processor(s) 204 may be implemented by one or more processors that execute instructions stored in memory 203.

In some embodiments, interface device 200 may be a standalone piece of hardware which forms part of the thermal management system 100 and allows the thermal management system 100 to communicate with other computing devices 206, 207 via the Internet 104. In some embodiments, interface device 200 may be a communication device, such as a mobile phone or tablet, which allows a user to communicate directly with the thermal management system 100. In other embodiments, interface device 200 may form part of an EV in which the thermal management system 100 is implemented. For example, in some embodiments, the interface device 200 may form part of the EV's infotainment system, or a mobile communication device, such as a smartphone, tablet, head-mounted display, or other communication device which is carried or worn by the user of the EV, or which may be mounted in the cabin of the EV. As used herein, an infotainment system is a software and hardware interface found in vehicles, designed to provide both information and entertainment to passengers and drivers. Infotainment systems typically integrate features such as GPS navigation, audio and video playback, Bluetooth connectivity for hands-free calling and music streaming, internet connectivity for browsing and downloading apps, and sometimes even vehicle diagnostics and control settings.

In some embodiments, aspects of the functionality such as user input/output, information collection and processing, and computing, may be in whole or in part provided by software running on interface device 200 and/or computing devices 206, 207. For example, in some embodiments, interface device 200 may form part of the thermal management system 100 and be capable of receiving instructions from a user and outputting information to a user via computing devices 206, 207. In other embodiments, interface device 200 may form part of a vehicle's infotainment system and may be capable of receiving instructions from a user and outputting information to a user directly via display I/O 205 and/or via computing devices 206, 207. As such, thermal management system 100 may be controlled as described herein by way of a graphical user interface implemented on the display I/O 205 of interface device 200 and/or via a graphical user interface implemented on computing devices 206, 207.

Interface device 200 may comprise memory 203, which itself may comprise one or more storage devices for storing program code executed by processor(s) 204 and data used during operation of processor(s) 204. Memory 203 may be a semiconductor medium including, e.g., a solid-state memory, a magnetic storage medium, an optical storage medium, and/or any other suitable type of memory. A storage device of memory 203 may be read-only memory (ROM) and/or random-access memory (RAM), for example.

Processor(s) 204 can be implemented, in whole or in part, using dedicated circuitry, such as an application specific integrated circuit (ASIC), a graphics processing unit (GPU), and/or a programmed field programmable gate array (FPGA) for performing any of various operations of the processor, for example.

The structure of the network interface(s) 201 is implementation-dependent and may vary between embodiments that support different types of connections and/or communication protocols, for example. The network interfaces 201 could enable communications over wired and/or wireless connections between the system and other servers and system. Moreover, network interface(s) 201 could also enable communications over wired and/or wireless connections between thermal management system 100 and interface device 200. In general, network interface(s) 201 include a physical interface such as a port, connector, antenna, antenna array, or other component to interface with a communication medium, and a receiver and/or transmitter to process received signals and/or transmit signals for transmission.

In some embodiments, network interface(s) 201 can include a vehicle interface 123 configured to communicate with other parts of an EV, for example. In some embodiments, the vehicle interface is configured to communicate via a vehicle communication and diagnostic system. In some embodiments, the vehicle communication and diagnostic system is a standard vehicle bus, such as a vehicle bus in accordance with the Society of Automotive Engineers' standard SAE J1939, or analogous systems, which are widely used by automotive manufacturers.

The network interface(s) 201 are an example of an input-output device and enables communications between the interface device 200 and other devices 206, 207 or systems over a data communication network such as the Internet 104. The data communication network may be any network capable of carrying data including any wired or wireless network. By way of non-limiting examples, the network may comprise an Internet network, Ethernet network, Control Area Network (CAN) bus, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these.

In some cases, the data communication network may be constructed from one or more computer network technologies, such as IEEE 802.3 (Ethernet), IEEE 802.11 and similar technologies. In other cases, the data communication network may comprise a personal area network (PAN), such as a Bluetooth® connection. In some cases, the data communication network may comprise a combination of multiple network types. For example, in some embodiments, communication between thermal management system 100 and the interface device 200 may be achieved via a wired connection, such as a CAN bus, and communication between the interface device 200 and other devices 206, 207 and/or other sources of data and information forming part of the data communication network (e.g., Internet 104) may be achieved via wireless data communication means.

In some embodiments, interface device 200 comprises a display I/O 205. Any of various types of displays could be implemented, including touchscreen displays that also enable user input. Other I/O modules could also or instead be provided. For example, one or more user input devices that allow a user to manually input information, actions and/or requests could be provided. Examples of user input devices include keyboards, computer mice, touch screens, buttons, dials, and switches. The display I/O 205 could also or instead include one or more output devices, such as output ports for exporting data.

In some embodiments, interface device 200 can include one or more positioning modules 202. Positioning module 202 is configured to determine the physical location of the EV over time, and may be implemented using any known technologies, including, but not limited, to Global Positioning System (GPS), GLObalnaya NAvigatsionnaya Sputnikovaya Sistema (GLONASS), WiFi positioning systems (WPS), Near Field Communication (NFC), Radio-Frequency Identification (RFID), Bluetooth Low Energy (BLE) beacons, Quick Response (QR) codes, or combinations thereof. As will be appreciated by the skilled reader, any other suitable technology may be used. The location information generated by and/or stored in the positioning module 202 can be used by the processor(s) 204 in implementing the methods described herein.

In some embodiments, the location information can be used in conjunction with known methods of creating geofences. For example, geographic zones can be established and the interface device 200 can use information from the positioning module 202 to determine whether the EV is located within a particular geographic zone or within a geofence. The various elements forming part of the interface device 200 may be coupled by way of data communication hub or any other suitable manner.

Examples of information that may be input (as described above) by a user into the thermal management system 100 of the present disclosure include, but are not limited to, information required to set the operational mode of the system, the expected charging time (i.e., when a user is expecting to charge battery pack 101), the expected charging location (i.e., the location in which the user is expecting to charge battery pack 101), the expected charging schedule (i.e., information in relation to when, how often and where the user expects to regularly charge battery pack 101), and the expected driving/use plan of the EV (e.g., the routes/trips that a user is expecting to take/make over a certain period of time).

Examples of information that may be obtained by the thermal management system 100 of the present disclosure include, but are not limited to, positioning information relating to the geographic location of the battery pack 101 (e.g., which can be received from the positioning module 202 and/or computing devices 206, 207), information usable to determine a charging schedule including information in relation to when and where the battery pack 101 is charged (e.g., which can be received from the positioning module 202 and/or computing devices 206, 207), traffic information relating to current, future or past traffic conditions (e.g., which can be received from the Internet 104 and/or computing devices 206, 207), information relating to current, future or past weather conditions, including ambient temperature information (e.g., which can be received from the Internet 104, the EV itself and/or computing devices 206, 207), battery cell 111 information, including for example cell temperature, cell voltage, cell current (e.g., which may be received from battery system manager 102).

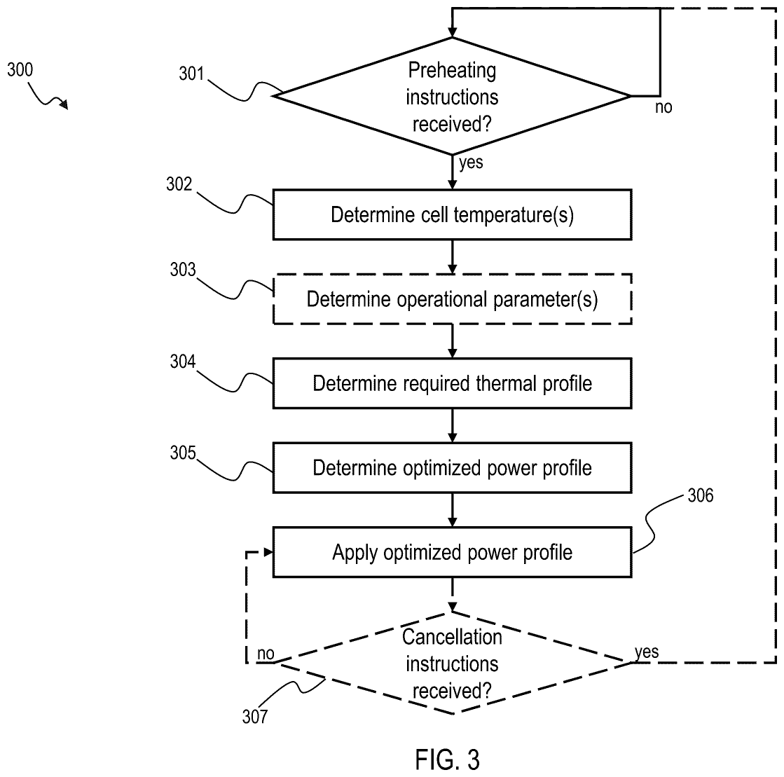

With reference to FIGS. 3 to 6, various operational modes of the thermal management system 100 set out above will now be described.

FIG. 3 shows a simplified flow chart setting out embodiments of a method 300 carried out by the thermal management system 100 when set into a manual mode of operation. At step 301, the thermal management system 100 awaits explicit instructions from a user to begin preheating of battery pack 101. As shown in FIG. 3, the method waits to receive preheating instructions until such time as instructions are received.

Preheating instructions can be provided by a user using any suitable means, including those described in detail elsewhere herein. Once preheating instructions are received, thermal management system 100 determines the temperature of one or more cells in the battery pack 101 at step 302.

As will be appreciated by the skilled reader, step 302 may be carried out in a number of different ways, depending in part on the configuration of the battery cells 111 in the battery pack 101, as well as the configuration of the heating elements 112 in the battery pack 101. For example, in some embodiments, it may be sufficient to determine the average temperature of all battery cells 111 in the pack. In other embodiments however, particularly embodiments described herein in which heating elements 112 are intercalated between battery cells 111 and heating may be applied in a more granular and precise way (i.e., at different levels for each heating element 112), thermal management system 100 may determine individual temperatures for each battery cell 111, or subsets of battery cells 111 in battery pack 101. In any event, if cell temperature(s) are determined at step 302, these can be factored into the determination of the required thermal profile (at step 304), and/or the determination of the optimized power profile (at step 305), as described in more detail elsewhere herein.

Then, at step 303, thermal management system 100 may optionally determine and/or receive operational parameter(s). These operational parameters may include, but are not limited to, positioning information relating to the geographic location of the battery pack 101 (i.e., the location of the EV), traffic information relating to current, future or past traffic conditions, information relating to current, future or past weather conditions, including ambient temperature information, battery cell 111 information including, for example, cell voltage and cell current. In any event, if operational parameter(s) are received and/or determined at step 303, these can be factored into the determination of the required thermal profile (at step 304), and/or the determination of the optimized power profile (at step 305), as described in more detail elsewhere herein.

Then, at step 304, a required thermal profile is determined by thermal management system 100. In some embodiments, the required thermal profile may be expressed in a temperature differential between the current temperature of one or more battery cells 111 in the battery pack 101 and a desired temperature of one or more battery cells 111 in the battery pack 101. For example, if the desired temperature is 5° C. and the current cell temperature is determined to be −5° C., the required thermal profile may be expressed as +10° C.

In some embodiments, the required thermal profile may be determined for one or more representative battery cells 111 in the battery pack 101. For example, the cell temperature determined at step 302 may be determined for each of a number of representative cells adjacent to a corresponding heating element 112. In such embodiments, thermal management system 100 may determine a thermal profile for each of a number of representative battery cells 111. The thermal profile determined at step 304 can therefore be composed of a number of component thermal profiles, each one of which component thermal profile may be associated with one or more representative battery cells 111 in battery pack 112. In such examples, the required thermal profile determined at step 304 may be expressed as +10° C., +9° C., +8.5° C., +11° C., +10.3° C., . . . , n, where n is the number of component thermal profiles forming part of the required thermal profile.

Then, at step 305, the determined required thermal profile is used to determine an optimized power profile. In general, the optimized power profile is the amount of power that needs to be provided from the battery pack 101 to heating elements 112 to conform to the required thermal profile determined at step 304, optionally within certain constraint conditions. For example, in a situation in which the required thermal profile is expressed in a temperature differential between the current temperature of one or more battery cells 111 in battery pack 101 and a desired temperature of the one or more battery cells 111 in battery pack 101, the optimized power profile may be the minimum power that needs to be applied to the heating elements 112 of battery pack 101 in order for the one or more battery cells 111 in battery pack 101 to be heated to the desired temperature from the current temperature, given certain constraints.

Examples of constraints include, but are not limited to, time constraints (e.g., the battery should be at a target temperature within a predetermined amount of time), available power constraints (i.e., the amount of power available in the battery), available energy constraints (i.e., the amount of energy available in the battery) temperature constraints (i.e., the external temperature), and capacity constraints (i.e., the capacity of the battery, which may decrease over time). In some embodiments, the battery system manager 102 and the one or more battery packs 101 may communicate information with each other to better assess the available power and/or energy of the battery packs 101. Such information may include, but is not limited to, state and condition information relating to each of battery packs 101.

In situations in which the determined required thermal profile comprises a plurality of component thermal profiles, the optimized power profile may be the minimum power that needs to be applied to each heating element 112 of the battery pack 101 in order for the one or more battery cells 111 in the battery pack 101 to be heated to the desired temperature from the current temperature, as indicated in the required thermal profile.

As will be appreciated by the skilled reader, because in some embodiments heating elements 112 may be individually controllable by control signals passing through drive medium 113, and battery system manager 102 may control the drive signal transmitted through drive medium 113 by intermittently switching the drive signal on and off using known techniques such as Pulse Width Modulation (PWM), the average power (and therefore heat) dissipated by heating elements 112 can be precisely controlled by controlling the duty cycle of the PWM drive signal, for example.

Because the average current is the current multiplied by the duty cycle of the drive signal, and the average power (i.e., dissipated heat) is equal to the square of the average current multiplied by the resistance of the heating element 112, the dissipated heat may thereby be controlled very precisely by controlling the duty cycle of the PWM drive signal. Moreover, in some embodiments, the battery system manager 102 may control the operation of each heating element 112 individually by way of drive medium 113, thereby increasing the flexibility and precision with which the battery cells 111 of battery pack 101 may be heated. Accordingly, thermal management system 100 may very precisely control the power provided to the heating elements 112 in order to achieve a required thermal profile using an optimized amount of power. As will be appreciated by the skilled reader, in some embodiments, an optimized amount of power will essentially be a minimum amount of power.

The aforementioned features provide a number of technical benefits, including, but not limited to, avoiding the overheating of a local area of a battery pack. Many known systems must use relatively low power heating in order to avoid local overheating. This leads to relatively slow battery heating. The apparatus, systems and methods disclosed herein avoid this by using precise PWM heater control and, in some embodiments, distributed heating elements interleaved between cells in a battery pack.

Moreover, the uniform heating provided by the apparatus, systems and methods disclosed herein further allow relatively low-power heating of a battery in situations in which it is desired to keep the battery above a certain temperature for an extended period of time. Such functionality shortens the necessary pre-heating (or preconditioning) time of a battery necessary to warm the battery to within its optimal operating temperature range before driving or charging in cold weather. In order to shorten such pre-heating times using known systems, aggressive pre-heating regimes (i.e., aggressive thermal/power profiles) are required, which regimes are known to increase local battery pack overheating and to reduce battery life.

Once the optimized power profile is determined in step 305, the thermal management system 100 will apply the optimized power profile and the battery system manager 102 will heat the battery pack accordingly. The optimized power profile will continue to be applied until such time as a cancellation instruction has been received at step 307. If cancellation instructions are received from the user (using any of the input means described in more detail elsewhere herein), the method returns to step 301. If, on the other hand, cancellation instructions are not received at step 307, then the battery system manager 102 will continue to apply the optimized power profile.

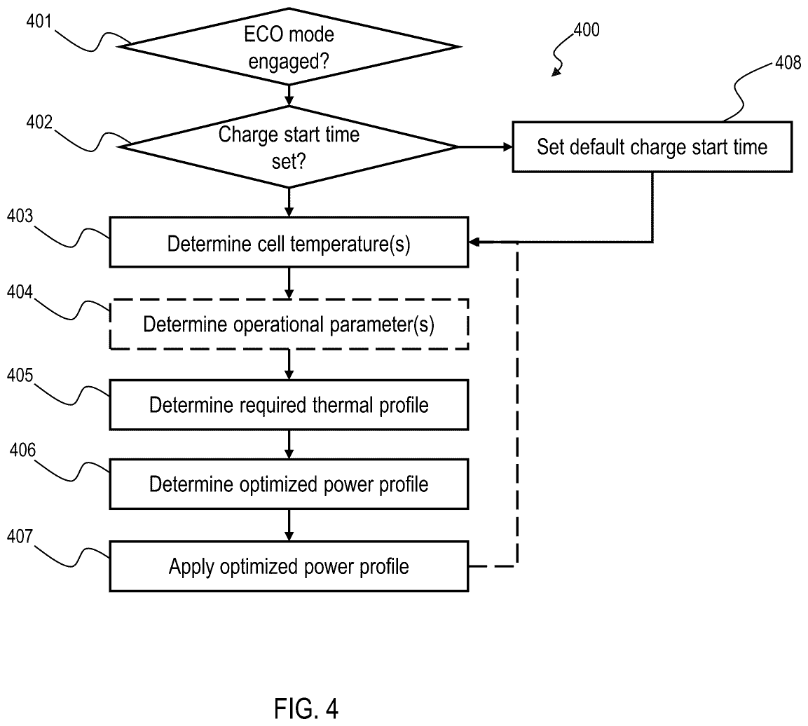

FIG. 4 shows a simplified flow chart setting out embodiments of a method 400 carried out by the thermal management system 100 when set into an economical mode (or “eco” mode) of operation. At step 401, the thermal management system 100 awaits explicit instructions from a user to enter into an eco-mode of heating. As shown in FIG. 4, the method waits to receive instructions to enter into eco-mode until such time as instructions are received. Instructions can be provided by a user using any suitable input means, including those described in detail elsewhere herein. Once instructions for entering into eco-mode are received, thermal management system 100 determines whether the user has set a charge start time. A charge start time is the acceptable delay between entering eco-mode and the time at which a user must begin charging battery pack 101.

The charge start time can be set by the user (e.g., 10 minutes) using any suitable input means, including those described in detail elsewhere herein. Alternatively, or additionally, a default charge start time can be set by the user or by the manufacturer of the system (by way of a firmware update, for example). If the user does not specify the charge start time when entering into eco-mode (which may be determined at step 402), the thermal management system 100 may set the charge start time to the default charge start time (e.g., 12 minutes) at step 408.

Then, at step 403, the thermal management system 100 will determine the cell temperature(s) one or more battery cells 111 in battery pack 101. As will be appreciated by the skilled reader, step 403 may be carried out in a number of different ways, depending in part on the configuration of the battery cells 111 in the battery pack 101, as well as the configuration of the heating elements 112 in battery pack 101, as described in more detail elsewhere herein.

Then, at step 404, thermal management system 100 may optionally determine operational parameter(s). These operational parameter(s) may include, but are not limited to, positioning information relating to the geographic location of the battery pack 101, traffic information relating to current, future or past traffic conditions, information relating to current, future or past weather conditions, including ambient temperature information, battery cell 111 information, including for example cell voltage and cell current. In a preferred embodiment, the ambient temperature information is determined at step 404.

Then, at step 405, a required thermal profile is determined by thermal management system 100. In some embodiments, the required thermal profile may be expressed in a temperature differential between the current temperature of one or more battery cells 111 in the battery pack 101 and a desired temperature of one or more battery cells 111 in the battery pack 101.

In some embodiments, the required thermal profile may be determined for one or more representative battery cells 111 in the battery pack 101. For example, the cell temperature determined at step 403 may be determined for each of a number of representative cells adjacent to corresponding heating element 112. In such embodiments, thermal management system 100 may determine a thermal profile for each of a plurality of representative battery cells 111. The thermal profile determined at step 405 can therefore be composed of a number of component thermal profiles, each one of which component thermal profile may be associated with one or more representative battery cells 111 in battery pack 101.

In some embodiments, the required thermal profile will be determined at step 405 by factoring in the charge start time set by the user or the default charge start time. For example, the default charge start time might be 12 minutes. In such a situation, the determined required thermal profile may require one or more cells to increase in temperature by a predetermined number of degrees Celsius over a period of 12 minutes.

Then, at step 406, the determined required thermal profile is used to determine an optimized power profile. In eco-mode, the optimized power profile may be the minimum power that needs to be applied to the heating elements 112 of the battery pack 101 in order for the one or more battery cells 111 in the battery pack 101 to be heated to a desired temperature from the current temperature within a predetermined period of time, and optionally considering other constraints/parameters.

For example, in one example, when a user starts eco-mode and does not set a charge start time, the thermal management system sets the charge start time to the default charge start time (e.g., 12 minutes), determines the cell temperature(s) and the ambient temperature to establish a thermal profile that will see the cell temperature(s) increase by a certain number of degrees Celsius in 12 minutes. A power profile is then calculated to determine the minimum amount of power required to heat the battery pack 101 in accordance with the thermal profile and in light of a given ambient air temperature. The use of operational parameters (Step 404) such as ambient air temperature will be particularly beneficial in situation in which a cold battery (e.g., an EV parked outside in the winter) is suddenly moved indoors (e.g., into a heated garage) to charge. By measuring the ambient air temperature, it is possible to forecast a lower required amount of power to achieve the thermal profile.

In situations in which the determined required thermal profile comprises a plurality of component thermal profiles, the optimized power profile may be the minimum power that needs to be applied to each heating element 112 of the battery pack 101 in order for the one or more battery cells 111 in the battery pack 101 to be heated to the desired temperature from the current temperature, as indicated in the required thermal profile, and given the operational parameter(s) (i.e., ambient air temperature). Again, the advantageous structure and operation of the presently described thermal management system 100 will allow it to very precisely control the power provided to the heating elements 112 in order to achieve a required thermal profile using an optimized (e.g., minimized) amount of power.

Then, at step 407, the optimized power profile is applied by the battery system manager 102 to the heating means 112 of the battery pack 101. In some embodiments, the thermal management system may periodically repeat steps 403 to 407 in order to ensure that the thermal profile is being implemented, and to ensure that the minimum amount of power is being drawn from the battery pack 101 to implement the thermal profile.

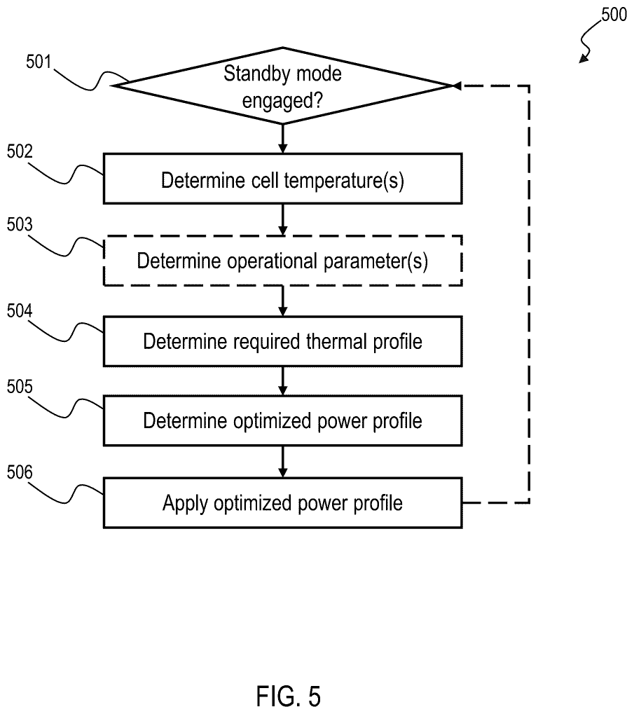

FIG. 5 shows a simplified flow chart setting out embodiments of a method 500 carried out by the thermal management system 100 when set into a “standby” mode. At step 501, the thermal management system 100 awaits explicit instructions from a user to enter into standby mode. As shown in FIG. 5, the method waits to receive instructions to enter into standby mode until such time as instructions are received. Instructions can be provided by a user using any suitable input means, including those described in detail elsewhere herein.

Then, at step 502, the thermal management system 100 will determine the cell temperature(s) of one or more battery cells 111 in battery pack 101. As will be appreciated by the skilled reader, step 403 may be carried out in a number of different ways, depending in part on the configuration of the battery cells 111 in the battery pack 101, as well as the configuration of the heating elements 112 in battery pack 101, as described in more detail elsewhere herein.

Then, at step 503, thermal management system 100 may optionally determine operational parameter(s). These operational parameter(s) may include, but are not limited to, positioning information relating to the geographic location of the battery pack 101, traffic information relating to current, future or past traffic conditions, information relating to current, future or past weather conditions, including ambient temperature information, battery cell 111 information, including for example cell voltage and cell current. In a preferred embodiment, the ambient temperature information is determined at step 503.

Then, at step 504, a required thermal profile is determined by thermal management system 100. In some embodiments, the required thermal profile may be expressed as a temperature above which one or more battery cells 111 in the battery pack 101 must be maintained by the heating elements 112.

In some embodiments, the required thermal profile may be determined for one or more representative battery cells 111 in the battery pack 101. For example, the cell temperature determined at step 502 may be determined for each of a number of representative cells adjacent to corresponding heating element 112. In such embodiments, thermal management system 100 may determine a thermal profile for each of a number of representative battery cells 111. The thermal profile determined at step 504 can therefore be composed of a number of component thermal profiles, each one of which component thermal profiles may be associated with one or more representative battery cells 111 in battery pack 112.

Then, at step 505, the determined required thermal profile is used to determine an optimized power profile. In embodiment of standby mode, the optimized power profile may be the minimum power that needs to be applied to the heating elements 112 of the battery pack 101 in order for the one or more battery cells 111 in the battery pack 101 to be maintained above a predetermined temperature. For example, in one example, when a user starts standby mode, the thermal management system determines the cell temperature(s) and the ambient temperature to establish a thermal profile that will see the cell temperature(s) be maintained at a predetermined temperature. A power profile is then calculated to determine the minimum amount of power required to carry out the thermal profile. The use of operational parameters (Step 503) such as ambient air temperature will be particularly beneficial in a situation in which a small amount of constant power may result in less overall energy usage when compared to no power being applied to the heating element until the temperature of the one or more battery cells 111 in the battery pack 101 falls below a predetermined temperature. This situation can result from, for example, a battery pack casing/housing freezing before the internal cell temperature(s) falls below a specific temperature. In such a situation, the low temperature of the casing/housing may counteract the heat generated by the heating elements. As such, in situations where the ambient air temperature is very low, it may be beneficial to provide a constant but very small amount of power to the heating elements in order to keep the battery pack 101 warm.

As with the other embodiments described herein, the thermal profile may comprise any number of component thermal profiles. Thus, the optimized power profile may be the minimum power that needs to be applied to each heating element 112 of the battery pack 101 in order to implement the thermal profile, given any the operational parameter(s) (i.e., ambient air temperature).

Then, at step 506, the optimized power profile is applied by the battery system manager 102 to the heating means 112 of the battery pack 101. In some embodiments, the thermal management system may periodically repeat steps 501 to 506 in order to ensure that the thermal profile is being implemented, and to ensure that the minimum amount of power is being drawn from the battery pack 101 to implement the thermal profile.

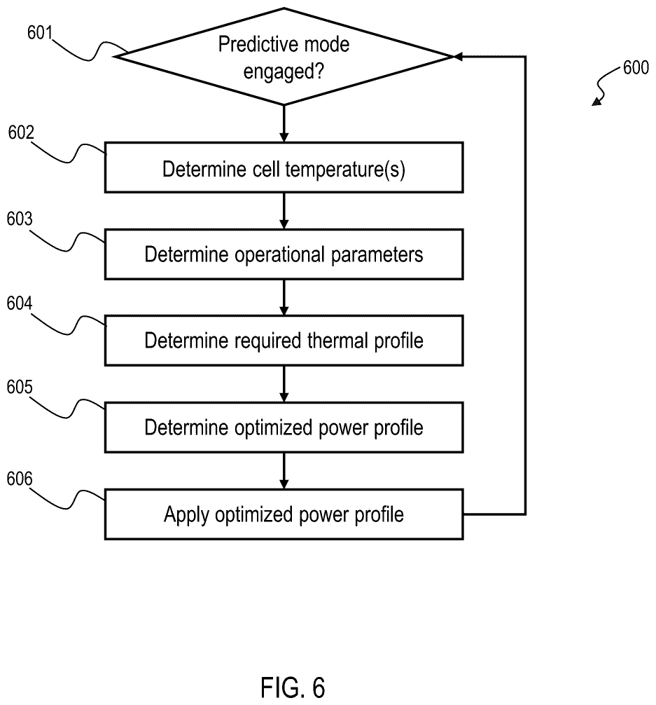

FIG. 6 shows a simplified flow chart of a method 600 relating to a predictive mode of operation of the thermal management system 100 of the present disclosure. The method starts when the predictive mode is engaged at step 601. The predictive mode may be engaged by the thermal management system 100 itself, or by a user of the system, as described in more detail elsewhere herein. Once engaged, the thermal management system 100 carries out step 602 by determining the temperature of the battery pack 101. The battery pack temperature can be determined by measuring the temperature of one or more of the battery cells 111 in battery pack 101. As such, the battery pack temperature may comprise a plurality of battery cell temperatures.

Then, at step 603, the thermal management system 100 may determine information and/or access stored information relating to operational parameters of the battery pack 101. In predictive mode, operational parameters may include, but are not limited to, information that may have been input by the user, such as the expected charging time (i.e., when a user is expecting to charge the battery pack), the expected charging location (i.e., the location in which the user is expecting to charge the battery pack), and the expected charging schedule (i.e., information in relation to when, how often and where the user expects to regularly charge the battery pack). Operational parameters may also include information that may be obtained by the thermal management system 100 of the present disclosure including, but not limited to, historical positioning information relating to the geographic location of the battery pack 101 (e.g., which can be received from the positioning module 202 and/or computing devices 206, 207), historical information usable to determine a charging schedule including information in relation to when and where the battery pack 101 is charged (e.g., which can be received from the positioning module 202 and/or computing devices 206, 207), traffic information relating to current, future or past traffic conditions (e.g., which can be received from the Internet 104 and/or computing devices 206, 207), information relating to current, future or past weather conditions, information relating to the location and availability of charging stations, including ambient temperature information (e.g., which can be received from the Internet 104 and/or computing devices 206, 207), battery cell 111 information, including for example cell temperature, cell voltage, cell current (e.g., which may be received from battery system manager 102).

Thus, example operational parameters might include a determination that the expected local weather forecast for the following day calls for a significant drop in temperature. Another example may be that a user typically uses their vehicle to travel between a first location (e.g., home) and a second location (e.g., work) at around 7 am every weekday morning and between the second location and the first location at around 7 pm every weekday evening. Another example of operational parameters could be the location, distance and traffic information to (e.g., time required to travel that distance), availability of a public charging station, and information relating to the load of the vehicle (e.g., how many people and what is the weight of the cargo travelling in the vehicle).

In some embodiments, the operational parameters can be used to determine a predictive power consumption profile for the battery pack. Such a predictive power consumption profile could include predictions as to when a user is most likely to require charging of the battery pack 101, as well as the state in which the battery pack 101 will be (e.g., State of Charge, battery pack/cell temperature, etc.) when the predicted charging event will occur.

In some embodiments, the operational parameters can be used to determine a predictive charging profile for the battery pack. Such a predictive charging profile could include predictions as to when a user is most likely to charge the battery pack 101, as well as the state in which the battery pack 101 will be (e.g., State of Charge, battery pack/cell temperature, etc.) when the predicted charging event will occur, based at least in part on past charging behavior.

As will be appreciated by the skilled reader, in some embodiments, the various operational parameters listed above may be input into one or more suitably trained machine learning models in order to provide predictive power consumption profiles and predictive charging profiles.

Then, at step 604, one or more of the operational parameters listed above and/or the predictive power consumption profile and/or the predictive charging profile may be used to determine the required thermal profile. As will be appreciated, the thermal profile may in part be based on the likelihood of a charging event occurring over a specific time period, such as a day, week, month or year, based on one or more operational parameters, and/or a predictive power consumption profile and/or a predictive charging profile. Moreover, local weather information, such as local temperature forecast information may also be used to calculate the likelihood of a charging event requiring pre-heating of the battery, based on the likelihood, for example, of the local temperature being below a specific threshold.

Accordingly, the required thermal profile determined at step 604 in the predictive mode may be expressed as the likelihood of the battery pack 101 requiring heating at any one time over a specific time period, such as a day, week, month or year.

Once the required thermal profile is determined at step 604, an optimized power profile is determined at step 605. In some embodiments, the optimized power profile may be a function of the thermal profile and the amount of battery power attributed by the thermal management system to heating the battery may be proportional to the likelihood of a charging event occurring. In other words, the optimized power profile may be determined to reduce the likelihood of requiring a pre-heating time that is greater than a pre-determined threshold, based on, for example, the predictive power consumption profile, the predictive charging profile and/or other operational parameters (such as forecasted local temperature information). In some embodiments, the optimized power profile will be applied to the heating elements by battery system manager 102 at step 606. In some embodiments, the thermal management system may periodically repeat steps 601 to 606 in order to update the required thermal profile and the optimized power profile.

In alternative examples, thermal management system 100 may use the predictive mode to keep the battery slightly above a certain temperature in anticipation of one or more charging and/or driving events. This can be particularly useful in situations in which a user would like to dispense with pre-heating (preconditioning) the battery. For example, a situation in which the user may wish to engage in charging and/or driving without requiring pre-heating. Such situations include, but are not limited to, a vehicle being parked outside in −20° C., a vehicle having a cold battery requiring a maximum amount of charging time within a given time window (e.g. an off-peak demand window during which electricity rates are less expensive).

In essence, the predictive PWM heater control described herein enables smarter energy usage, smoother power profiles, and improved battery pack readiness as compared to known system which rely on crude on/off relay control. These benefits are especially advantageous in time-critical or power-constrained situations. While the applicant's teachings described herein are in conjunction with various embodiments for illustrative purposes, it is not intended that the applicant's teachings be limited to such embodiments as the embodiments described herein are intended to be examples only. On the contrary, the applicant's teachings described and illustrated herein encompass various alternatives, modifications, and equivalents, without departing from the embodiments described herein, the general scope of which is defined in the appended claims.

1. A battery system manager for at least one battery pack having a plurality of battery cells and a plurality of heating elements, the battery system manager comprising:
one or more computer processors; and
one or more computer readable storage media for storing computer-implemented instructions, wherein the one or more computer processors are configured to execute the computer-implemented instructions to cause the battery system manager to:
determine, in response to an activation signal, a required thermal profile, the required thermal profile relating to one or more battery cell temperatures of the plurality of battery cells over a period of time;
receive operational information relating to the at least one battery pack;
calculate an optimized power profile required to execute the required thermal profile based at least in part on the operational information; and
modulate a driver signal for the plurality of heating elements based on the calculated optimized power profile, wherein the modulated driver signal causes the plurality of heating elements to heat the plurality of battery cells in accordance with the required thermal profile.

2. The battery system manager of claim 1, wherein the required thermal profile relates to changes in the one or more battery cell temperatures in order to allow safe charging of the at least one battery pack at a specific time.

3. The battery system manager of claim 1, wherein the required thermal profile relates to one or more changes in the one or more battery cell temperatures in order to allow safe charging of the at least one battery pack at multiple times during a specific time period.

4. The battery system manager of claim 1, wherein the one or more battery cell temperatures are determined for each battery cell in a subset of the plurality of battery cells.

5. The battery system manager of claim 1, wherein the operational information includes information that is input by a user, and wherein the at least one battery pack is a power source of an electric vehicle and the information input by the user includes one or more of information required to set an operational mode of the system, information relating to when a user is expecting to charge battery pack, information relating to a location in which the user is expecting to charge battery pack, information relating to when, how often and/or where the user expects to regularly charge battery pack, and information relating to the expected use plan of the electric vehicle.

6. The battery system manager of claim 1, wherein the operational information includes information that is be obtained by the battery system manager, and wherein the at least one battery pack is a power source of an electric vehicle and the information that is obtained by the battery system manager includes positioning information relating to a geographic location of the battery pack, information usable to determine a charging schedule including information in relation to when and where the battery pack is charged, traffic information relating to current, future or past traffic conditions, information relating to current, future or past weather conditions, information relating to current, future or past ambient temperatures, information relating to the operation of one or more of the plurality of battery cells.

7. The battery system manager of claim 1, wherein the optimized power profile corresponds to the amount of power required to be delivered to the plurality of heating elements over a period of time in order for the one or more battery cell temperatures to conform to the required thermal profile.

8. The battery system manager of claim 1, wherein the optimized power profile corresponds to the minimum amount of power required to be delivered to the plurality of heating elements over a period of time in order for the one or more battery cell temperatures to conform to the required thermal profile.

9. The battery system manager of claim 1, wherein modulating a driver signal for the plurality of heating elements based on the calculated optimized power profile includes modulating the driver signal using pulse width modulation in order to deliver specific amounts of power to the heating elements over a period of time.

10. A method of heating at least one battery pack having a plurality of battery cells and a plurality of heating elements, the method comprising:
determining, in response to an activation signal, a required thermal profile, the required thermal profile relating to one or more battery cell temperatures of the plurality of battery cells over a period of time;
receiving operational information relating to the at least one battery pack;
calculating an optimized power profile required to execute the required thermal profile based at least in part on the operational information; and
modulating a driver signal for the plurality of heating elements based on the calculated optimized power profile, wherein the modulated driver signal causes the plurality of heating elements to heat the plurality of battery cells in accordance with the required thermal profile.

11. The method of claim 10, wherein the required thermal profile relates to changes in the one or more battery cell temperatures in order to allow safe charging of the at least one battery pack at a specific time.

12. The method of claim 10, wherein the required thermal profile relates to one or more changes in the one or more battery cell temperatures in order to allow safe charging of the at least one battery pack at multiple times during a specific time period.

13. The method of claim 10, wherein the one or more battery cell temperatures are determined for each battery cell in a subset of the plurality of battery cells.

14. The method of claim 10, wherein the operational information includes information that is input by a user, and wherein the at least one battery pack is a power source of an electric vehicle and the information input by the user includes one or more of information required to set an operational mode of the system, information relating to when a user is expecting to charge battery pack, information relating to a location in which the user is expecting to charge battery pack, information relating to when, how often and/or where the user expects to regularly charge battery pack, and information relating to the expected use plan of the electric vehicle.

15. The method of claim 10, wherein the operational information includes information that is be obtained by the battery system manager, and wherein the at least one battery pack is a power source of an electric vehicle and the information that is obtained by the battery system manager includes positioning information relating to a geographic location of the battery pack, information usable to determine a charging schedule including information in relation to when and where the battery pack is charged, traffic information relating to current, future or past traffic conditions, information relating to current, future or past weather conditions, information relating to current, future or past ambient temperatures, information relating to the operation of one or more of the plurality of battery cells.

16. The method of claim 10, wherein the optimized power profile corresponds to the amount of power required to be delivered to the plurality of heating elements over a period of time in order for the one or more battery cell temperatures to conform to the required thermal profile.

17. The method of claim 10, wherein the optimized power profile corresponds to the minimum amount of power required to be delivered to the plurality of heating elements over a period of time in order for the one or more battery cell temperatures to conform to the required thermal profile.

18. The method of claim 10, wherein modulating a driver signal for the plurality of heating elements based on the calculated optimized power profile includes modulating the driver signal using pulse width modulation in order to deliver specific amounts of power to the heating elements over a period of time.

19. A thermal management system for at least one battery pack having a plurality of battery cells, the thermal management system comprising:
a plurality of heating elements; and
a battery system manager in accordance with claim 1.

20. The thermal management system of claim 19, wherein each of the plurality of heating elements are intercalated between each of the plurality of battery cells.
